(19) United States
(12) Patent Application Publication
(10) Pub. No.: US 2020/0365851 A1
(43) Pub. Date: Nov. 19, 2020

(54) VEHICLE BATTERY UNIT

(71) Applicant: HONDA MOTOR CO., LTD., Tokyo (JP)

(72) Inventors: Hiroyuki OZAWA, Saitama (JP); Eiji KOIKE, Saitama (JP); Tetsuhisa SAKAMOTO, Saitama (JP); Yosuke YAMAGISHI, Saitama (JP); Nariyuki YOSHINAGA, Saitama (JP); Ryo SHINODA, Saitama (JP)

(73) Assignee: HONDA MOTOR CO., LTD., Tokyo (JP)

(21) Appl. No.: 16/871,559

(22) Filed: May 11, 2020

(30) Foreign Application Priority Data
May 16, 2019 (JP) 2019-093127

(51) Int. Cl. H01M 2/10; H01M 10/613; H01M 10/625; H01M 10/6556; H01M 10/48; H01M 10/6568; B60L 58/26; B60L 50/64

(52) U.S. Cl. CPC H01M 2/1077; H01M 10/613; H01M 10/625; H01M 10/6556; H01M 2220/20; H01M 10/6568; B60L 58/26; B60L 50/64; H01M 10/482

(57) ABSTRACT

A vehicle battery unit includes: a plurality of battery modules, each of which including a plurality of cells having cell terminals on top; battery cooling units having refrigerant passages through which a refrigerant passes; a supply pipe for introducing a refrigerant to the battery cooling unit; a discharge pipe for discharging the refrigerant from the battery cooling unit; voltage detection lines extending from the plurality of battery modules; a battery control device to which the voltage detection line is connected; and a battery case which accommodates the plurality of battery modules, the battery cooling unit, the supply pipe, the discharge pipe, the voltage detection line, and the battery control device. The supply pipe and the discharge pipe are disposed below the cell terminal and output terminals of the plurality of battery modules and are covered with a pipe cover. The voltage detection line is disposed above the pipe cover.

### CROSS-REFERENCE TO RELATED APPLICATIONS

The present application claims the benefit of priority of Japanese Patent Application No. 2019-093127, filed on May 16, 2019, the content of which is incorporated herein by reference.

### TECHNICAL FIELD

Japanese Patent No. 6064730 describes a battery pack in which a plurality of battery modules are accommodated in a case and a cooling module is arranged below the case.

### BACKGROUND ART

The battery pack described in Japanese Patent No. 6064730 has room for improvement in cooling efficiency because the cooling module is arranged outside the case. When the cooling module is arranged in the case, a space for accommodating the battery module may be narrowed. Also, in the vehicle battery unit, it is necessary to prevent liquid from entering the inside of the case. Even when liquid enters the inside of the case or when the liquid leaks from the cooling module in the case, it is necessary to prevent a high-voltage portion from being exposed to the water.

### SUMMARY

The invention provides a vehicle battery unit which can prevent a high-voltage portion from being exposed to the water.

According to an aspect of the invention, there is provided a vehicle battery unit including: a plurality of battery modules, each of which including a plurality of cells having cell terminals on top, the plurality of cells being laminated; battery cooling units disposed below the plurality of battery modules and having refrigerant passages through which a refrigerant passes; a supply pipe configured to introduce a refrigerant to the battery cooling unit; a discharge pipe configured to discharge the refrigerant from the battery cooling unit; voltage detection lines extending from the plurality of battery modules; a battery control device to which the voltage detection line is connected and which is disposed above the plurality of battery modules; and a battery case which accommodates the plurality of battery modules, the battery cooling unit, the supply pipe, the discharge pipe, the voltage detection line, and the battery control device, wherein: the supply pipe and the discharge pipe are disposed below the cell terminal and output terminals of the plurality of battery modules and are covered with a pipe cover; and the voltage detection line is disposed above the pipe cover.

According to the invention, even when the liquid enters the inside of the case or when the liquid leaks from the cooling module in the case, it is possible to prevent the high-voltage portion from being exposed to the water.

### BRIEF DESCRIPTION OF THE DRAWINGS

FIG. 1 is a schematic side view illustrating an overall structure of a vehicle on which a vehicle battery unit according to an embodiment of the invention is mounted.

FIG. 2 is a plan view illustrating an underfloor structure of the vehicle in FIG. 1.

FIG. 3 is a perspective view of the vehicle battery unit in FIG. 1.

FIG. 4 is a plan view of the vehicle battery unit in FIG. 1 with a case lid portion removed.

FIG. 5 is a plan view illustrating a cooling structure of the vehicle battery unit in FIG. 1.

FIG. 6 is a perspective view illustrating a cooling structure of the vehicle battery unit in FIG. 5 provided with a pipe cover.

FIG. 7 is a perspective view of a cable unit.

FIG. 8 is a cross-sectional view taken along the line A-A in FIG. 2.

FIG. 9 is a cross-sectional view taken along the line B-B in FIG. 2.

FIG. 10 is an enlarged view of a portion C in FIG. 4.

FIG. 11 is a cross-sectional view taken along the line D-D in FIG. 10.

FIG. 12 is a perspective view of a battery module.

FIG. 13 is an exploded perspective view of the battery module in FIG. 12.

### DESCRIPTION OF EMBODIMENTS

Hereinafter, an embodiment of a vehicle battery unit of the invention will be described with reference to the drawings. In addition, the drawings shall be viewed in the direction of reference letters, and in the following description, front and rear, left and right, up and down are described according to the direction viewed from an operator of a vehicle. In the drawings, the front of the vehicle is indicated by FR, the rear is indicated by Rr, the left side is indicated by L, the right side is indicated by R, the upper side is indicated by U, and the lower side is indicated by D.

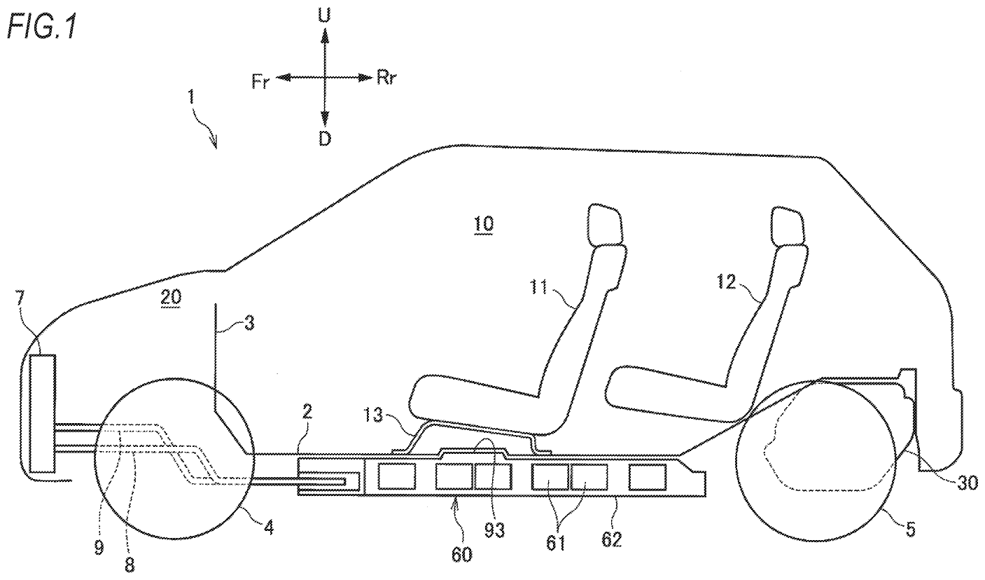

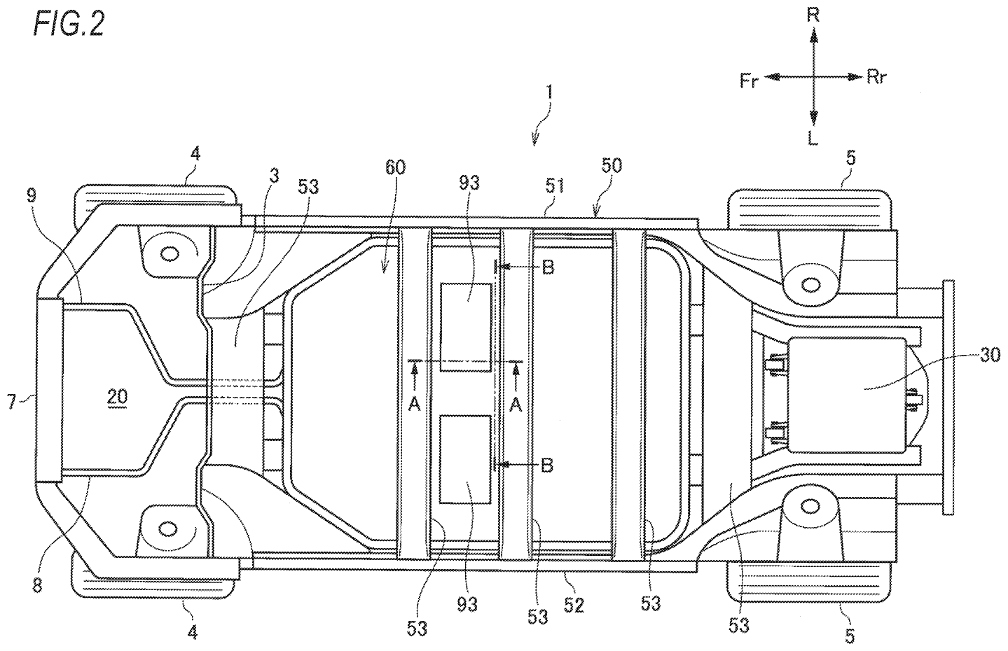

As illustrated in FIGS. 1 and 2, a vehicle 1 is defined by a floor panel 2 and a dash panel 3 into a cabin 10 and a front room 20 in front of the cabin 10. The cabin 10 is provided with a front seat 11 and a rear seat 12. A drive device unit 30 is provided below the floor panel 2 behind the rear seat 12. The drive device unit 30 drives left and right rear wheels 5. That is, in the vehicle 1, the left and right rear wheels 5 are used as drive wheels and left and right front wheels 4 are used as driven wheels.

Below the cabin 10, a battery unit 60 is arranged. The battery unit 60 is configured by accommodating a plurality of battery modules 61 in a battery case 62 and is arranged below the floor panel 2 in the cabin 10.

A vehicle body frame 50 includes a pair of left and right side sills 51 and 52 extending in a front-rear direction and a plurality of cross members 53 extending in a vehicle width direction (hereinafter, referred to also as a left-right direction) and connecting the side sills 51 and 52 to each other.

The drive device unit 30 includes an electric motor, a Power Control Unit (PCU) as an electric motor control device which controls the electric motor, and a power transmission mechanism which transmits the power of the electric motor to the rear wheels 5.

In the front room 20, a cooling device 7 for cooling the battery unit 60 and the like is provided.

The cooling device 7 includes a radiator provided on the forefront of the vehicle 1. The cooling device 7 and the battery unit 60 are connected via an outer supply pipe 8 and an outer discharge pipe 9. An electric pump (not illustrated) is provided in the outer supply pipe 8 or the outer discharge pipe 9.

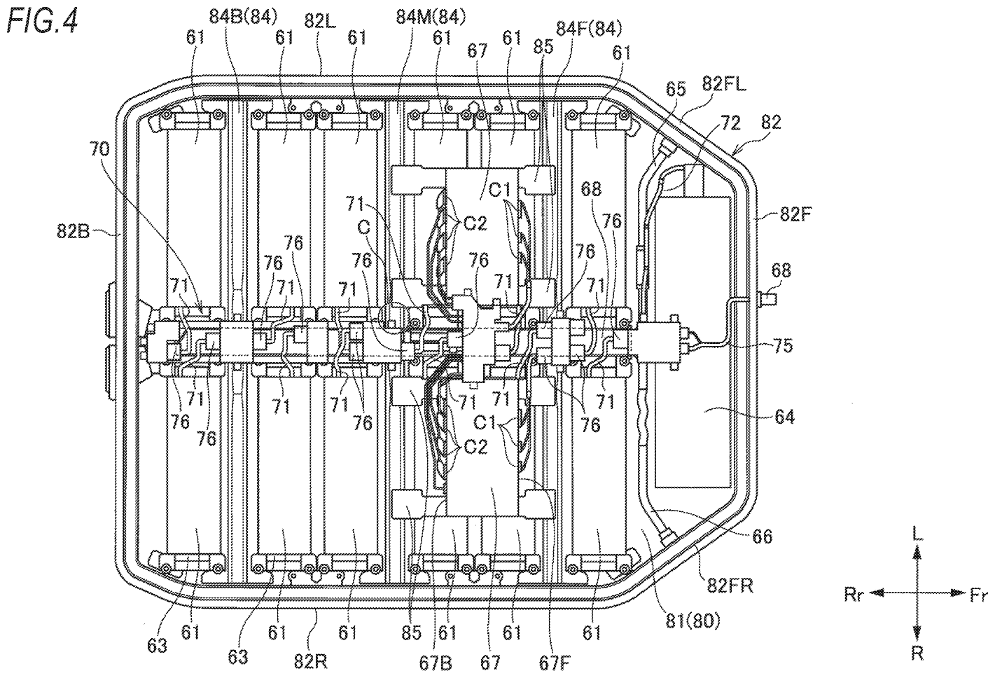

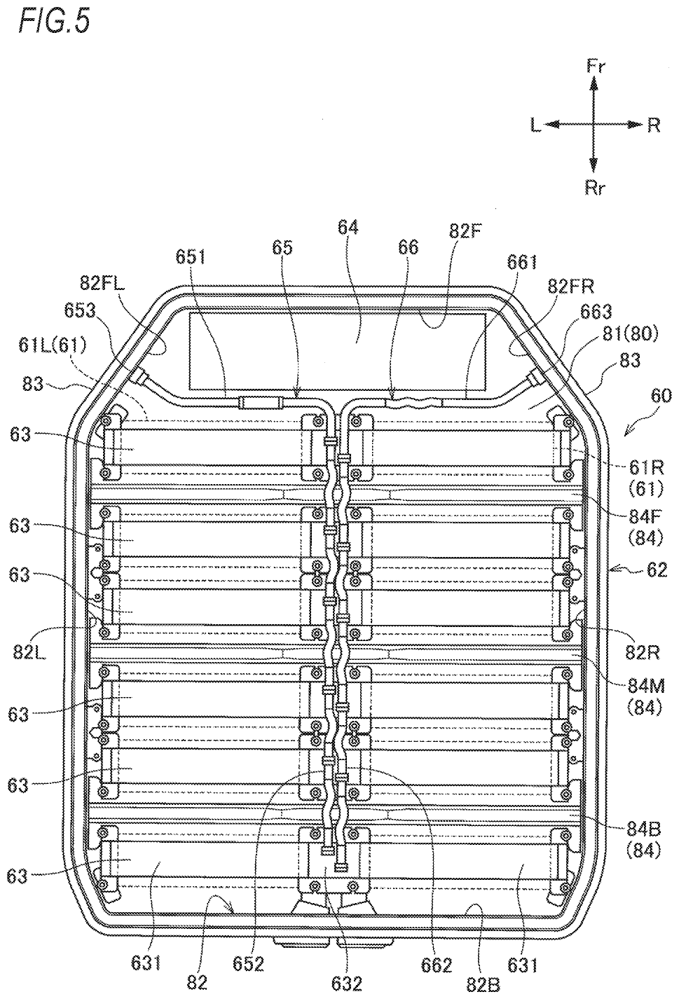

As illustrated in FIGS. 4 and 5, the battery unit 60 includes a plurality of battery modules 61, a battery cooling unit 63 for cooling the battery module 61, an electric connection box 64 arranged on the front side of the battery module 61, a battery control device 67 for controlling a plurality of battery modules 61, a supply pipe 65 for introducing a refrigerant from outside the battery case 62 to the battery cooling unit 63, a discharge pipe 66 for discharging the refrigerant from the battery cooling unit 63 to the outside of the battery case 62, and the battery case 62 accommodating the battery module 61, the battery cooling unit 63, the electric connection box 64, the battery control device 67, the supply pipe 65, and the discharge pipe 66.

The plurality of battery modules 61 are arranged in the battery case 62 in the front-rear direction and the left-right direction. The battery unit 60 of the embodiment includes a total of twelve battery modules 61 arranged six in the front-rear direction and two in the left-right direction.

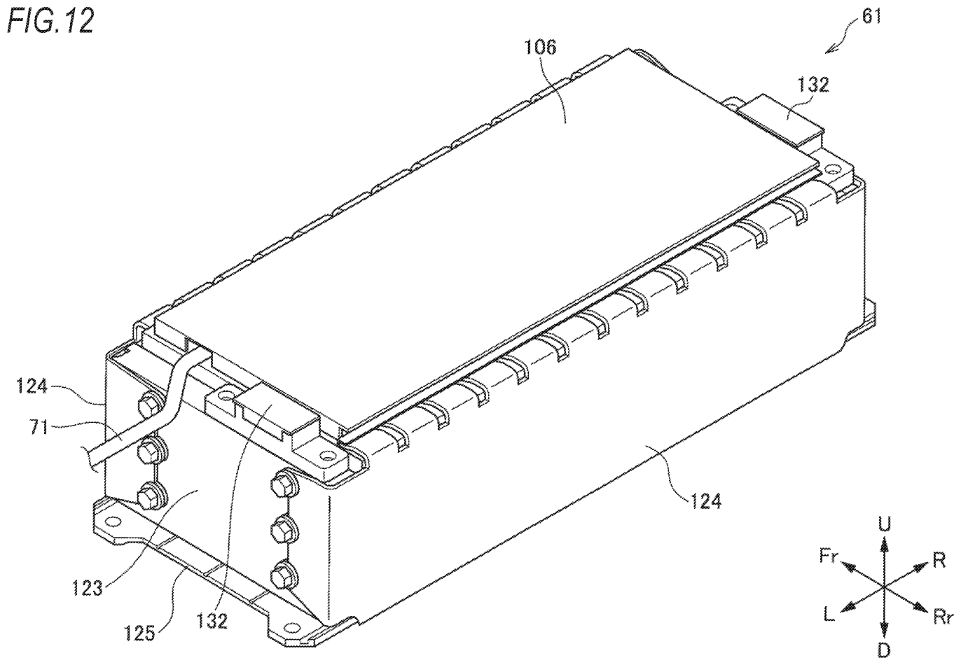

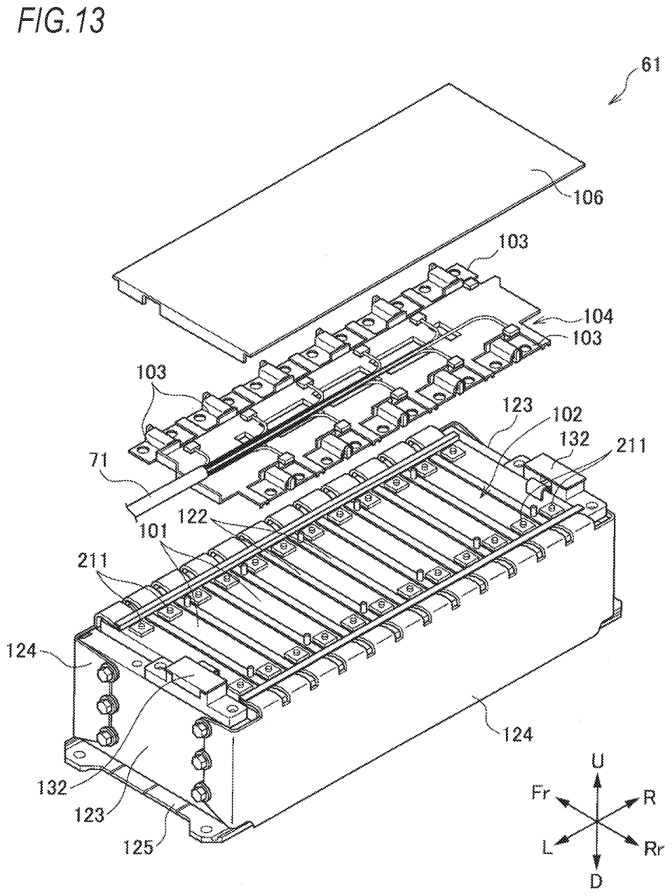

As illustrated in FIGS. 12 and 13, the battery module 61 includes, a cell laminate 102 formed by laminating a plurality of cells 101, a plurality of bus bars 103 connecting cell terminals 211 of the cells 101, which are arranged on the upper surface side of the cell laminate 102, electrically in series, a bus bar plate 104 for holding the plurality of bus bars 103, a plurality of voltage detection lines 71 which are arranged on the upper surface side of the bus bar plate 104 to detect the voltage of each cell 101, and a top cover 106 which is disposed on the upper surface side of the bus bar plate 104 and covers the cell terminals 211 of the cells 101 and the bus bars 103.

The cell laminate 102 is configured by alternately laminating the plurality of cells 101 and a plurality of insulating plates 122 in a laminating direction. The cell laminate 102 includes a pair of end plates 123 arranged at both ends of the cell laminate 102 in the laminating direction, a pair of side frames 124 connecting the pair of end plates 123, and a lower plate 125 arranged on the lower surface of the cell laminate 102. Output terminals 132 for transmitting and receiving electric power between the battery module 61 and an external electric device are provided on the upper surfaces of the pair of end plates 123.

Returning to FIG. 4, each battery module 61 has a rectangular parallelepiped shape and is arranged so that a longitudinal direction (laminating direction) is set to be parallel to a left-right direction and a transverse direction is set to be parallel to a front-rear direction in a plan view. From each battery module 61, the voltage detection line 71 for detecting the voltage of each cell constituting the battery module 61 extends toward the center of the battery case 62 in the left-right direction. Further, the voltage detection lines 71 extending from each battery module 61 may be combined with at least one temperature detection line for detecting the temperature of the battery module 61. The voltage detection line 71 extending from each battery module 61 is connected via a connector 76 to a cable unit 70 described below arranged between two battery modules 61 adjacent in the left-right direction.

As illustrated in FIG. 5, the battery cooling unit 63 is disposed below the battery module 61 and has a refrigerant passage through which refrigerant passes. In the battery unit 60 of the embodiment, since one battery cooling unit 63 cools two battery modules 61 arranged in the left-right direction, six battery cooling units 63 arranged in the front-rear direction are provided.

The battery cooling unit 63 includes a pair of cooling unit main bodies 631 arranged in a left-right direction and arranged below a pair of battery modules 61 arranged in the left-right direction and a pipe connection portion 632 provided between a pair of cooling unit main bodies 631 arranged in the left-right direction and connected to the supply pipe 65 and the discharge pipe 66. When the refrigerant is supplied from the supply pipe 65 to the pipe connection portion 632, the supplied refrigerant passes through a refrigerant passage formed inside the cooling unit main body 631, and is then discharged from the pipe connection portion 632 to the discharge pipe 66.

The electric connection box 64 accommodates a contact for disconnecting and connecting a conductive path of battery power, a current sensor for detecting a current of the battery power, a ground fault detecting circuit for detecting a ground fault of the battery module 61, and the like. The electric connection box 64 of the embodiment is located on the front side of a pair of battery modules 61 arranged in the front row and arranged in the left-right direction. The left end of the electric connection box 64 is located inside the left end of the left battery module 61 and the right end of the electric connection box 64 is located inside the right end of the right battery module 61.

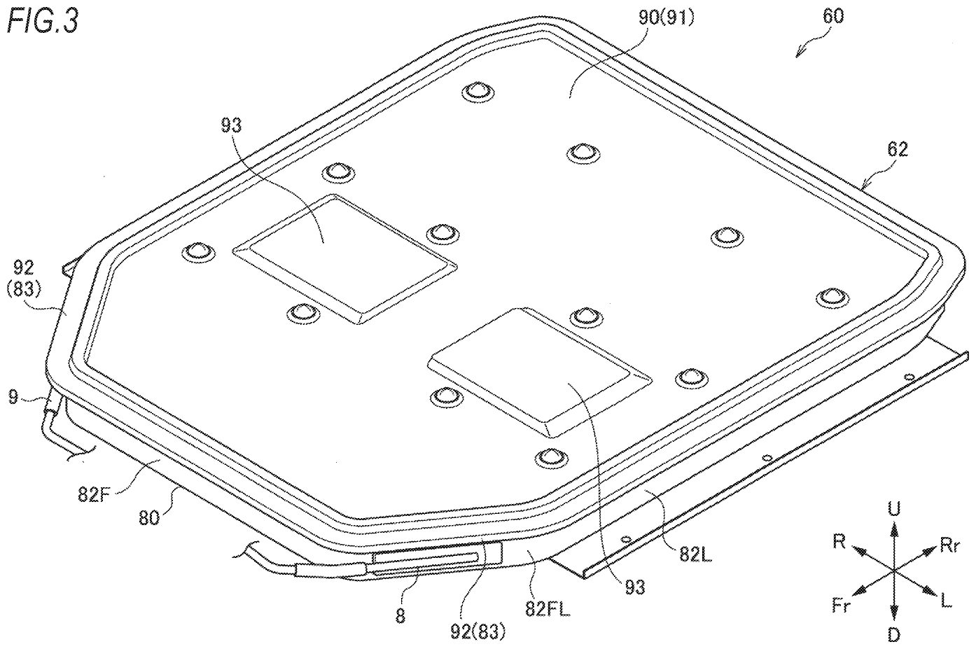

As illustrated in FIGS. 3 to 5, the battery case 62 includes a case body 80 accommodating the battery module 61, the battery cooling unit 63, the electric connection box 64, the supply pipe 65, and the discharge pipe 66 and a case lid portion 90 covering an upper opening of the case body 80.

The case body 80 includes a bottom portion 81, a side wall portion 82 rising from an outer edge of the bottom portion 81, and a flange portion 83 extending outward from the upper end of the side wall portion 82. The side wall portion 82 includes a left wall portion 82L and a right wall portion 82R facing each other in the left-right direction, a front wall portion 82F located on the front side of the electric connection box 64, a left inclined wall portion 82FL which connects the front wall portion 82F and the left wall portion 82L, a right inclined wall portion 82FR which connects the front wall portion 82F and the right wall portion 82R, and a rear wall portion 82B which connects rear ends of the left wall portion 82L and the right wall portion 82R,

In the case body 80, three cross members 84 are extended in the left-right direction while being spaced apart in the front-rear direction. In the cross member 84, the center in the left-right direction is lower in height. When the three cross members 84 are sequentially referred to as a first cross member 84F, a second cross member 84M, and a third cross member 84B from the front, in the front-rear direction, the electric connection box 64 and the battery module 61 in the front row are arranged between the front wall portion 82F of the case body 80 and the first cross member 84F and the battery modules 61 in the second and third rows are arranged between the first cross member 84F and the second cross member 84M, and further the battery modules 61 in the fourth and fifth rows are arranged between the second cross member 84M and the third cross member 84B. In addition, a battery module 61 in the sixth row is arranged between the third cross member 84B and the rear wall portion 82B of the case body 80.

As illustrated in FIG. 3, the case lid portion 90 includes a lid body portion 91 which covers the upper opening of the case body 80 and a flange portion 92 which extends outward from a peripheral edge of the lid body portion 91. The flange portion 92 is overlapped with the flange portion 83 of the case body 80 and fastened via a plurality of bolts interposing a seal (not shown) therebetween.

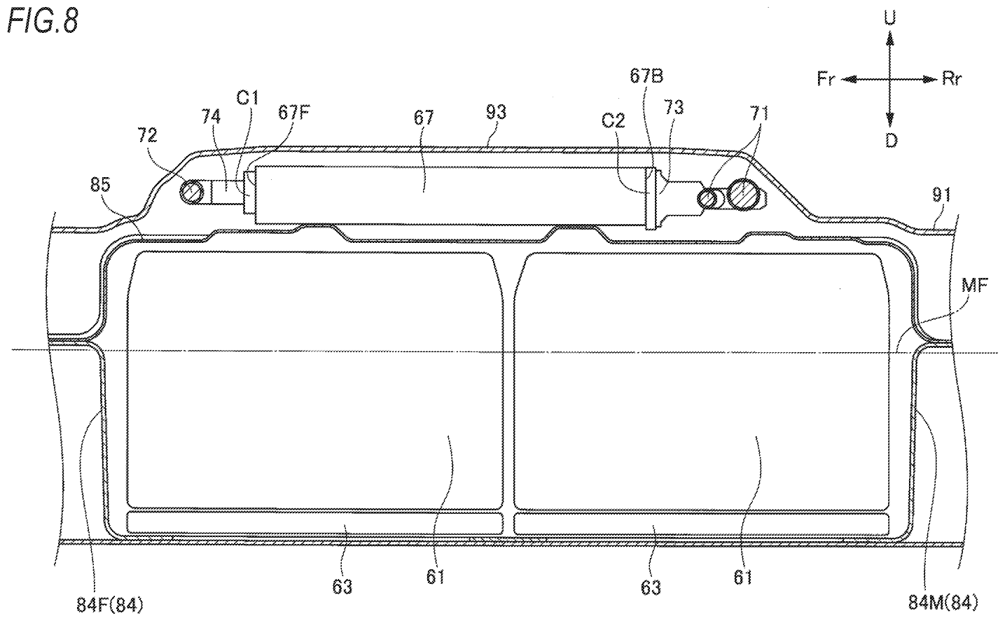

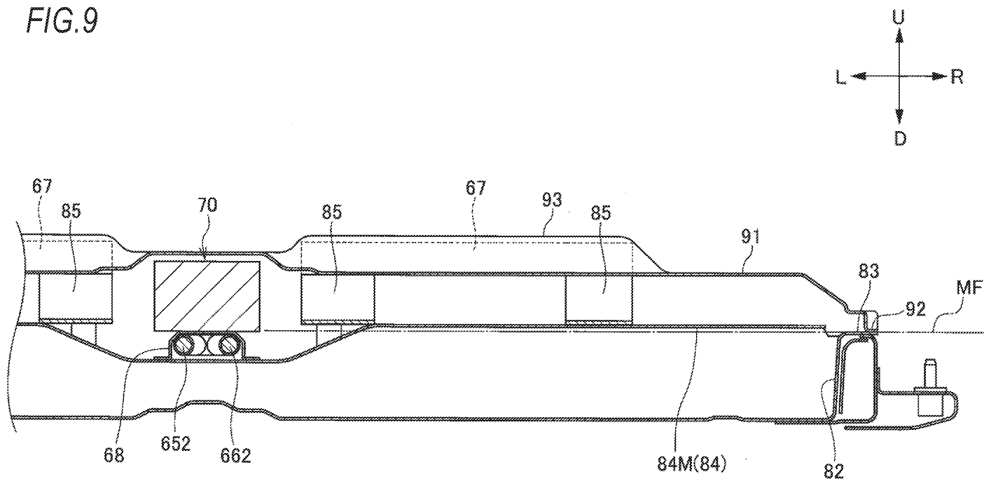

As illustrated in FIGS. 8 and 9, a mating surface MF between the case body 80 and the case lid portion 90 is located below the cell terminal 211, the output terminal 132, the battery control device 67, and the voltage detection line 71 in the vertical direction. Therefore, even when water intrudes from the outside due to the break of the seal, the high-voltage portion is hardly exposed to water.

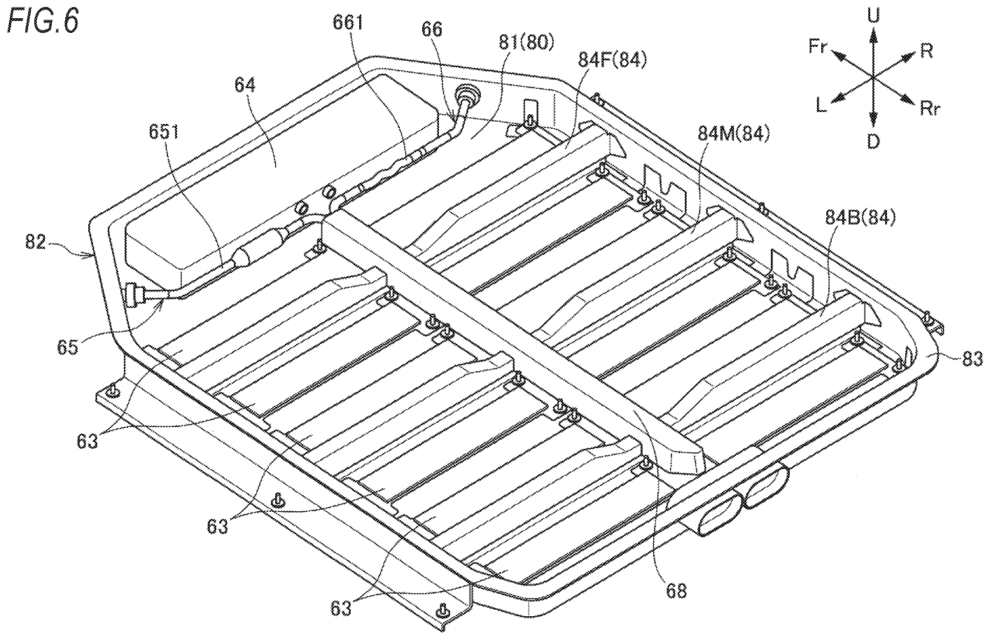

As illustrated in FIGS. 5 and 6, the supply pipe 65 includes a first supply pipe portion 651 passing between the electric connection box 64 and the left battery module 61L located in the front row and a second supply pipe portion 652 passing between the left and right battery modules 61. The discharge pipe 66 includes a first discharge pipe portion 661 passing between the electric connection box 64 and the right battery module 61R located in the front row and a second discharge pipe portion 662 passing between the left and right battery modules 61.

The supply pipe 65 and the discharge pipe 66 are arranged below (at a lower position in the vertical direction) the cell terminal 211 of each battery module 61 and the output terminals 132 of the plurality of battery modules and are covered with a pipe cover 68. Since the supply pipe 65 and the discharge pipe 66 are disposed below the cell terminal 211 and the output terminal 132 of the battery module, the cell terminal 211 and the output terminal 132 of the battery module are hardly exposed to water.

The supply pipe 65 and the discharge pipe 66 are arranged so that their heights are substantially constant. With this configuration, the accumulation of air in the pipe can be suppressed, so that there is no need to provide a breathing mechanism, and thus the structure can be simplified.

Also, an outer pipe connection portion 653 of the supply pipe 65 is joined to the left inclined wall portion 82FL of the battery case 62 and an outer pipe connection portion 663 of the discharge pipe 66 is joined to the right inclined wall portion 82FR of the battery case 62.

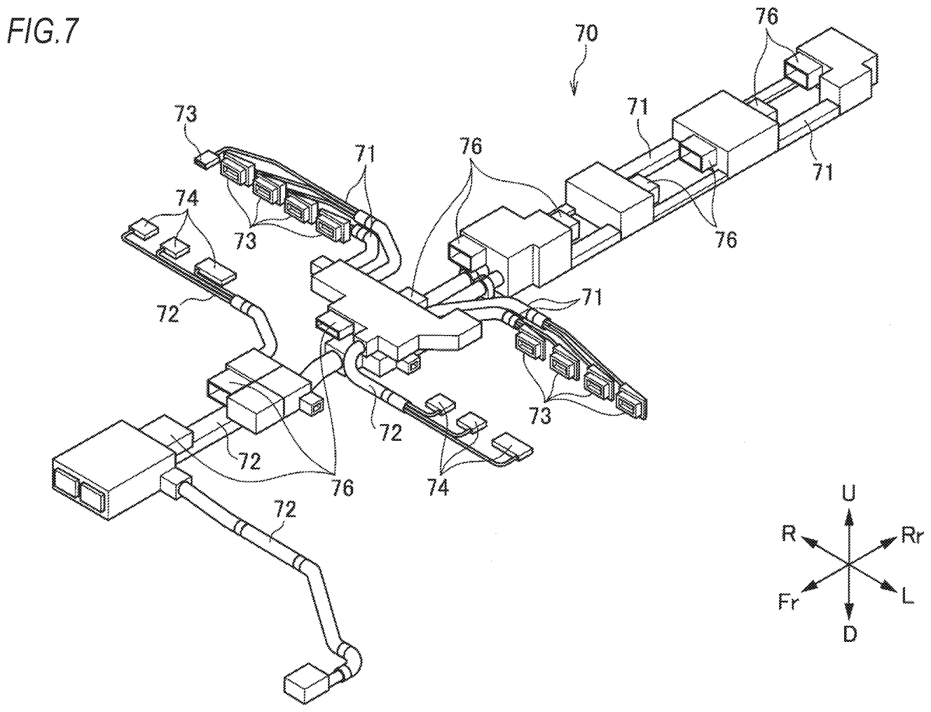

As illustrated in FIGS. 4 and 7, the cable unit 70 is an aggregation of the voltage detection line 71 extending from each battery module 61 and a signal line 72 extending from the electric connection box 64. The cable unit 70 is disposed between two battery modules 61 adjacent to each other in the left-right direction and extends above the pipe cover 68 in the front-rear direction. The voltage detection line 71 is connected to the battery control device 67 via nine voltage detection connectors 73 located on the rear side of the battery control device 67. On the other hand, the signal line 72 is connected to the battery control device 67 via six power supply connectors 74 located on the front side. By grouping the voltage detection line 71 and the signal line 72 into the cable unit 70, the handling of wirings is improved. Further, since the cable unit 70 including the voltage detection line 71 is disposed above the pipe cover 68, the voltage detection line 71 is also hardly exposed to water in addition to being highly space-efficient. This makes it difficult for the high-voltage portion, which becomes a high voltage inside the battery case 62, to be exposed to water.

Here, the pipe cover 68 will be described more specifically.

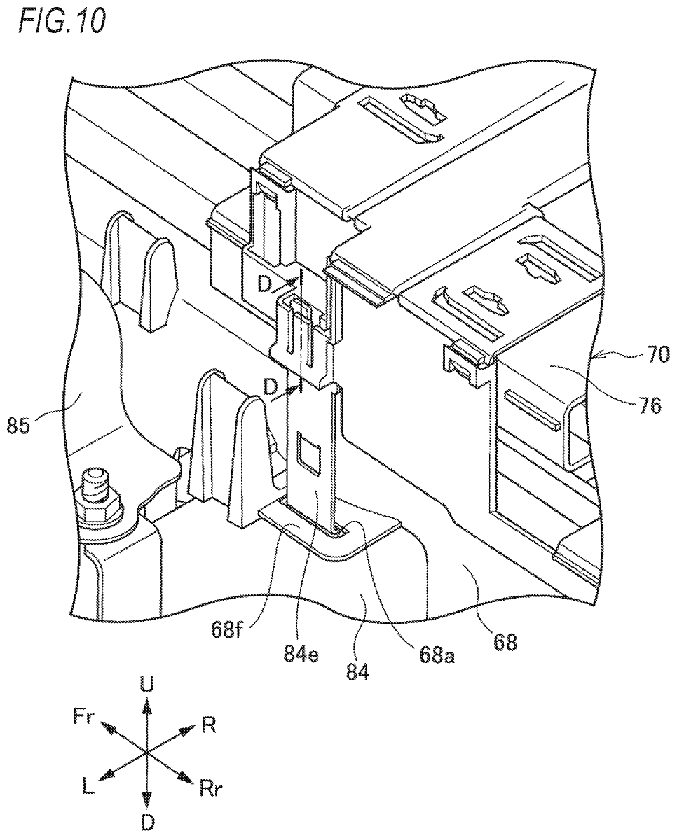

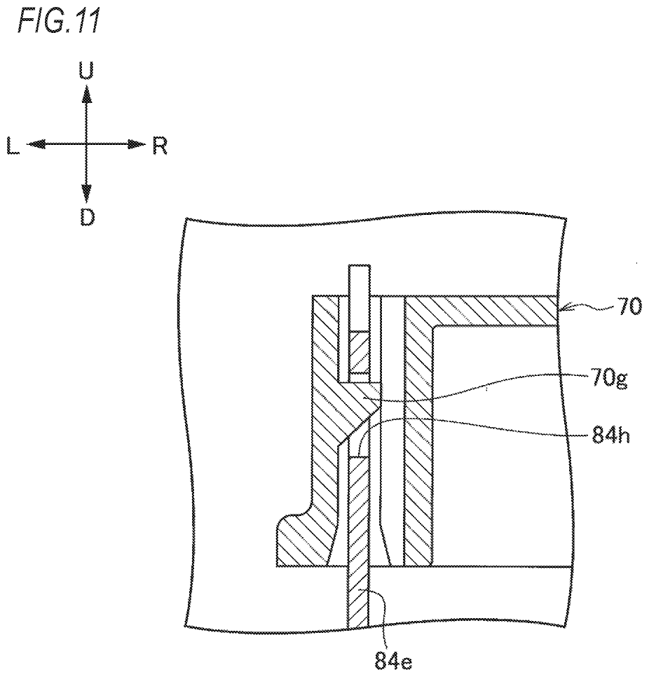

The pipe cover 68 is made of a plate member having a substantially U-shaped cross section. As described above, the pipe cover 68 covers the supply pipe 65 and the discharge pipe 66 from above and the cable unit 70 is disposed above the pipe cover 68. The pipe cover 68 extends from the rear side of the electric connection box 64 across the three cross members 84 to the rear wall portion 82B of the battery case 62. As illustrated in FIG. 10, each cross member 84 is provided with a locking piece 84e protruding upward and the pipe cover 68 and the cable unit 70 are fixed to the locking piece 84e of the cross member 84. That is, in the pipe cover 68, a through hole 68a through which the locking piece 84e penetrates is provided in a cover flange 68f extending along the upper surface of the cross member 84. Further, as illustrated in FIG. 11, the cable unit 70 is provided with an engaging claw 70g which engages with a locking hole 84h provided in the locking piece 84e. Thereby, the pipe cover 68 and the cable unit 70 are securely fixed to the cross member 84, and thus the pipe cover 68 and the cable unit 70 are prevented from being relatively shifted.

The battery control devices 67 are a battery ECUs for controlling the plurality of battery modules 61 and a pair of battery control devices 67 are provided on the left and right. The battery control device 67 is supported by a pair of brackets 85 bridged between the first cross member 84F and the second cross member 84M and is disposed above the battery modules 61 in the second and third rows. By fixing the battery control device 67 by using the cross member 84, the battery control device 67 can be stably held.

As illustrated in FIGS. 1 to 3, the lid body portion 91 of the case lid portion 90 is provided with raised portions 93 which are upwardly convex at positions corresponding to the pair of left and right battery control devices 67 in a plan view. As illustrated in FIG. 8, at least a part of the battery control device 67 overlaps the raised portion 93 in the vertical direction. As a result, the raised portion 93 provided on the case lid portion 90 becomes an air pocket, and thus the battery control device 67 is less likely exposed to water. In addition, as illustrated in FIG. 1, the raised portion 93 is located between seat rails 13 of the front seat 11 arranged in the cabin in the front-rear direction. Therefore, the space under the seat can be effectively used.

As illustrated in FIGS. 4 and 8, in the battery control device 67, first connectors C1 to which the signal line 72 extending from the electric connection box 64 is connected are arranged on a front surface 67F of the battery control device 67 side by side in the left and right direction and second connectors C2 to which the voltage detection lines 71 extending from the plurality of battery modules 61 are connected are arranged on a rear surface 67B of the battery control device 67 side by side in the left-right direction.

A power supply connector 74, which is a connection portion of the signal line 72 integrated in the cable unit 70, is connected to the first connector C1 and a voltage detection connector 73, which is a connection portion of the voltage detection line 71 integrated in the cable unit 70, is connected to the second connector C2.

The embodiment described above can be appropriately modified, improved, and the like.

For example, the pipe cover 68 is made of a plate material having a substantially U-shaped cross section. However, it is not limited to this and may have any shape as long as it covers the supply pipe 65 and the discharge pipe 66 from above.

At least the following matters are described in this specification. In addition, although the corresponding components in the embodiment described above are shown in parentheses, the invention is not limited to this.

(1) A vehicle battery unit (battery unit 60) which includes a plurality of battery modules (battery modules 61) configured by laminating a plurality of cells (cells 101) having cell terminals (cell terminals 211) on top, battery cooling units (battery cooling units 63) disposed below the plurality of battery modules and having refrigerant passages through which a refrigerant passes, a supply pipe (supply pipe 65) for introducing a refrigerant to the battery cooling unit, a discharge pipe (discharge pipe 66) for discharging the refrigerant from the battery cooling unit, voltage detection lines (voltage detection lines 71) extending from the plurality of battery modules, a battery control device (battery control device 67) to which the voltage detection line is connected and which is disposed above the plurality of battery modules, and a battery case (battery case 62) which accommodates the plurality of battery modules, the battery cooling unit, the supply pipe, the discharge pipe, the voltage detection line, and the battery control device, where

the supply pipe and the discharge pipe are disposed below the cell terminal and output terminals (output terminals 132) of the plurality of battery modules and are covered with a pipe cover (pipe cover 68), and

the voltage detection line is disposed above the pipe cover.

According to (1), since the supply pipe and the discharge pipe are arranged below the cell terminal and the output terminal of the battery module, the cell terminal and the output terminal of the battery module are hardly to be exposed to the water. In addition, since the supply pipe and the discharge pipe are covered with a pipe cover and the voltage detection line is disposed above the pipe cover, the voltage detection line is also hardly to be exposed to the water. This makes it difficult for the high-voltage portion, which becomes a high voltage inside the battery case, to be exposed to the water.

Further, since the voltage detection line is arranged above the pipe cover covering the supply pipe and the discharge pipe, space efficiency is high.

(2) The vehicle battery unit according to (1), where

each battery module includes,

a cell laminate (cell laminate 102) configured by laminating the plurality of cells, and

a pair of terminal members (end plates 123) arranged at both ends of the cell laminate in a laminating direction of the plurality of cells, and

the output terminals are fixed to upper portions of the pair of terminal members.

According to (2), since the output terminals are fixed to the upper portions of the pair of terminal members, the output terminal is more reliably prevented from being exposed to the water.

(3) The vehicle battery unit according to (1) or (2), where

the battery case includes a cross member (cross member 84) extending in a vehicle width direction, and

the pipe cover and the voltage detection line are fixed to the cross member.

According to (3), since the pipe cover and the voltage detection line are fixed to the cross member, a fixing member for fixing the pipe cover and the voltage detection line can be eliminated, and thus the manufacturing cost can be reduced.

(4) The vehicle battery unit according to (3), where

a part of the voltage detection line is incorporated in the cable unit (cable unit 70),

the cross member is provided with a locking piece (locking piece 84e) protruding upward,

the pipe cover has a through hole (through hole 68a) through which the locking piece passes, and

the cable unit has an engagement portion (engaging claw 70g) which engages with the locking piece.

According to (4), since the pipe cover and the cable unit can be securely fixed to the cross member, the pipe cover and the cable unit are prevented from being relatively displaced.

(5) The vehicle battery unit according to any one of (1) to (4), where

the battery case includes a case body (case body 80) and a cover (case lid portion 90) which seals an upper opening of the case body, and

a mating surface (mating surface MF) of the case body and the cover is located below the cell terminal, the output terminal, the battery control device, and the voltage detection line.

According to (5), even when the water enters from the outside due to the break of the seal, the high-voltage portion is less likely to be exposed to the water.

(6) The vehicle battery unit according to any one of (1) to (5), where

the battery case includes a case body (case body 80) and a cover (case lid portion 90) which seals an upper opening of the case body,

the cover has a raised portion (raised portion 93) which is convex upward,

the battery control device is arranged in the raised portion in a plan view, and

at least a part of the battery control device overlaps with the raised portion in a vertical direction.

According to (6), the raised portion provided on the cover becomes an air pocket, and thus the battery control device is less likely to be exposed to the water.

1. A vehicle battery unit comprising:
a plurality of battery modules, each of which including a plurality of cells having cell terminals on top, the plurality of cells being laminated;
battery cooling units disposed below the plurality of battery modules and having refrigerant passages through which a refrigerant passes;
a supply pipe configured to introduce a refrigerant to the battery cooling unit;
a discharge pipe configured to discharge the refrigerant from the battery cooling unit;
voltage detection lines extending from the plurality of battery modules;
a battery control device to which the voltage detection line is connected and which is disposed above the plurality of battery modules; and
a battery case configured to accommodate the plurality of battery modules, the battery cooling unit, the supply pipe, the discharge pipe, the voltage detection line, and the battery control device, wherein:
the supply pipe and the discharge pipe are disposed below the cell terminal and output terminals of the plurality of battery modules and are covered with a pipe cover; and
the voltage detection line is disposed above the pipe cover.

2. The vehicle battery unit according to claim 1, wherein:
each battery module includes:
a cell laminate configured by laminating the plurality of cells; and
a pair of terminal members arranged at both ends of the cell laminate in a laminating direction of the plurality of cells; and
the output terminals are fixed to upper portions of the pair of terminal members.

3. The vehicle battery unit according to claim 1, wherein:
the battery case includes a cross member extending in a vehicle width direction; and
the pipe cover and the voltage detection line are fixed to the cross member.

4. The vehicle battery unit according to claim 3, wherein:
a part of the voltage detection line is incorporated in the cable unit;
the cross member is provided with a locking piece protruding upward;
the pipe cover has a through hole through which the locking piece passes; and
the cable unit has an engagement portion which engages with the locking piece.

5. The vehicle battery unit according to claim 1, wherein:
the battery case includes a case body and a cover which seals an upper opening of the case body; and
a mating surface of the case body and the cover is located below the cell terminal, the output terminal, the battery control device, and the voltage detection line.

6. The vehicle battery unit according to claim 1, wherein:
the battery case includes a case body and a cover which seals an upper opening of the case body;
the cover has a raised portion which is convex upward;
the battery control device is arranged in the raised portion in a plan view; and
at least a part of the battery control device overlaps with the raised portion in a vertical direction.
